(19) United States
(12) Patent Application Publication
(10) Pub. No.: US 2026/0280019 A1
(43) Pub. Date: Sep. 17, 2026

(54) TRACTION BATTERY PACK CELL STACK SUPPORT ASSEMBLY

(71) Applicant: Ford Global Technologies, LLC, Dearborn, MI (US)

(72) Inventors: Jie Deng, Novi, MI (US); Xiaogang Zhang, Novi, MI (US)

(21) Appl. No.: 19/076,687

(22) Filed: Mar. 11, 2025

(51) Int. Cl. H01M 50/291; B60L 50/64; H01M 10/0525; H01M 10/613; H01M 10/625; H01M 10/6557; H01M 10/6567; H01M 10/658; H01M 50/211; H01M 50/249; H01M 50/271

(52) U.S. Cl. CPC H01M 50/291; B60L 50/64; H01M 10/0525; H01M 10/613; H01M 10/625; H01M 10/6557; H01M 10/6567; H01M 10/658; H01M 50/211; H01M 50/249; H01M 50/271; H01M 2220/20

(57) ABSTRACT

A traction battery pack cell stack assembly includes a first support fin, a second support fin, and a spacer sandwiched between the first support fin and the second support fin to provide a support assembly of a cell stack. The spacer spaces the first support fin from the second support fin to provide a plurality of liquid coolant channels through the spacer assembly.

### TECHNICAL FIELD

This disclosure details exemplary support assemblies within a battery pack and, more particularly, to a support assembly that can both support a cell stack and guide coolant between cells of a cell stack.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. As part of an immersion thermal management system, liquid coolant can be moved through the traction battery pack to help manage thermal energy within the traction battery pack.

### SUMMARY

In some aspects, the techniques described herein relate to a traction battery pack cell stack assembly, including: a first support fin; a second support fin; and a spacer sandwiched between the first support fin and the second support fin to provide a support assembly of a cell stack, the spacer spacing the first support fin from the second support fin to provide a plurality of liquid coolant channels through the spacer assembly.

In some aspects, the techniques described herein relate to an assembly, wherein the first support fin and the second support fin extend from a first enclosure structure on a first side of the cell stack to a second enclosure structure on an opposite, second side of the cell stack.

In some aspects, the techniques described herein relate to an assembly, wherein the first enclosure structure is an enclosure tray and the second enclosure structure is an enclosure cover.

In some aspects, the techniques described herein relate to an assembly, wherein the first support fin and the second support fin each have a C-shaped cross-sectional profile.

In some aspects, the techniques described herein relate to an assembly, wherein the first support fin and the second support fin each have a divider section, and at least one attachment section extending transversely from the divider section.

In some aspects, the techniques described herein relate to an assembly, wherein the first attachment section includes a first attachment section bonded to an enclosure assembly on a first side of the cell stack, and a second attachment section bonded to the enclosure assembly on an opposite, second side of the cell stack.

In some aspects, the techniques described herein relate to an assembly, wherein the first attachment section is bonded to an enclosure cover of the enclosure assembly, and the second attachment section is bonded to an enclosure tray of the enclosure assembly.

In some aspects, the techniques described herein relate to an assembly, wherein the spacer is a corrugated sheet.

In some aspects, the techniques described herein relate to an assembly, wherein the spacer includes a plurality of foam strips.

In some aspects, the techniques described herein relate to an assembly, wherein the spacer includes a plurality of thermal barrier strips.

In some aspects, the techniques described herein relate to an assembly, wherein the spacer is a corrugated sheet, wherein the first support fin and the corrugated sheet establish a plurality of first liquid coolant channels, and the second support fin and the corrugated sheet establish a plurality of second liquid coolant channels, the first and second liquid coolant channels each opening to a first side of the cell stack and to an opposite, second side of the cell stack.

In some aspects, the techniques described herein relate to an assembly, further including a first thermal barrier and a second thermal barrier that sandwich the first support fin, the second support fin, and the spacer.

In some aspects, the techniques described herein relate to an assembly, wherein the support assembly is disposed between axially adjacent battery cells within the cell stack.

In some aspects, the techniques described herein relate to an assembly, wherein the support assembly is compressible.

In some aspects, the techniques described herein relate to an assembly, wherein the first support fin and the second support fin are a metal or a metal alloy.

In some aspects, the techniques described herein relate to an assembly, wherein the cell stack is within an interior of an enclosure, the cell stack including a plurality of battery cells disposed along a cell stack axis, the support assembly disposed between the plurality of battery cells along the cell stack axis.

In some aspects, the techniques described herein relate to an assembly, wherein the spacer is a corrugated sheet that is configured to flex to permit movement of the first support fin relative to the second support fin along the cell stack axis.

In some aspects, the techniques described herein relate to an assembly, further including a dielectric liquid coolant disposed within liquid coolant channels.

In some aspects, the techniques described herein relate to a traction battery pack assembly, including: at least one first battery cell of a cell stack; at least one second battery cell of the cell stack; and a support assembly that supports the cell stack within an enclosure assembly, the support assembly is disposed axially between the at least one first battery cell and the at least one second battery cell, the support assembly establishing a plurality of coolant channels configured to guide a liquid coolant through the cell stack between the at least one first battery cell and the at least one second battery cell.

In some aspects, the techniques described herein relate to a traction battery pack assembly, wherein the support assembly is connected to the enclosure assembly on a first side of the cell stack and on an opposite second side of the cell stack.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective, schematic view of the battery pack of FIG. 1.

FIG. 3 illustrates an expanded view of the battery pack of FIG. 2.

FIG. 4 illustrates a section view of the battery pack taken at line 4-4 in FIG. 2 and showing a portion of a cell stack disposed between an enclosure cover and an enclosure tray.

FIG. 5 illustrates a close-up view of an area of FIG. 4 showing a portion of a support assembly and portions of battery cells of the cell stack.

FIG. 6 illustrates a close-up view of an area of FIG. 4 showing a portion of a support assembly and portions of battery cells of the cell stack.

FIG. 7 illustrates the support assembly of FIGS. 5 and 6 according to an exemplary embodiment of the present disclosure.

FIGS. 8A-8E illustrate support assemblies according to other exemplary embodiments of the present disclosure.

### DETAILED DESCRIPTION

An immersion thermal management system can be used to manage thermal energy in a traction battery pack. In such a traction battery pack, at least some components of the traction battery pack are immersed in a liquid coolant within an enclosure. The immersed components can include a cell stack.

This disclosure is directed toward guiding the liquid coolant through the cell stack using channels that are provided by a support assembly. During operation, cells may swell. The support assembly can be somewhat compressible, which can facilitate accommodating the swelling. The support assembly can help to support the cell stack at an elevated position within the enclosure.

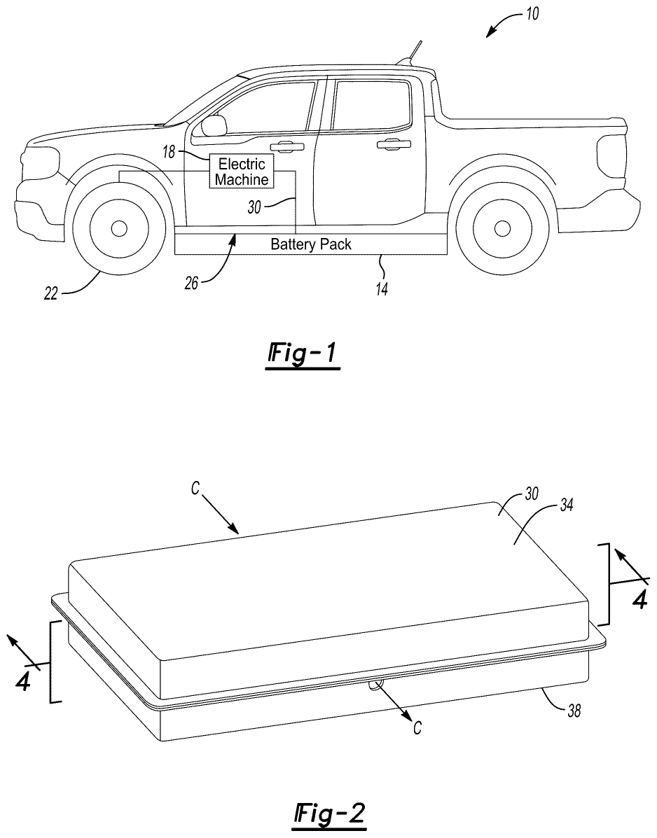

With reference to FIG. 1, an electrified vehicle 10 includes a traction battery pack 14, an electric machine 18, and wheels 22. The traction battery pack 14 powers an electric machine 18, which can convert electrical power to mechanical power to drive the wheels 22. The traction battery pack 14 can be a relatively high-voltage battery.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

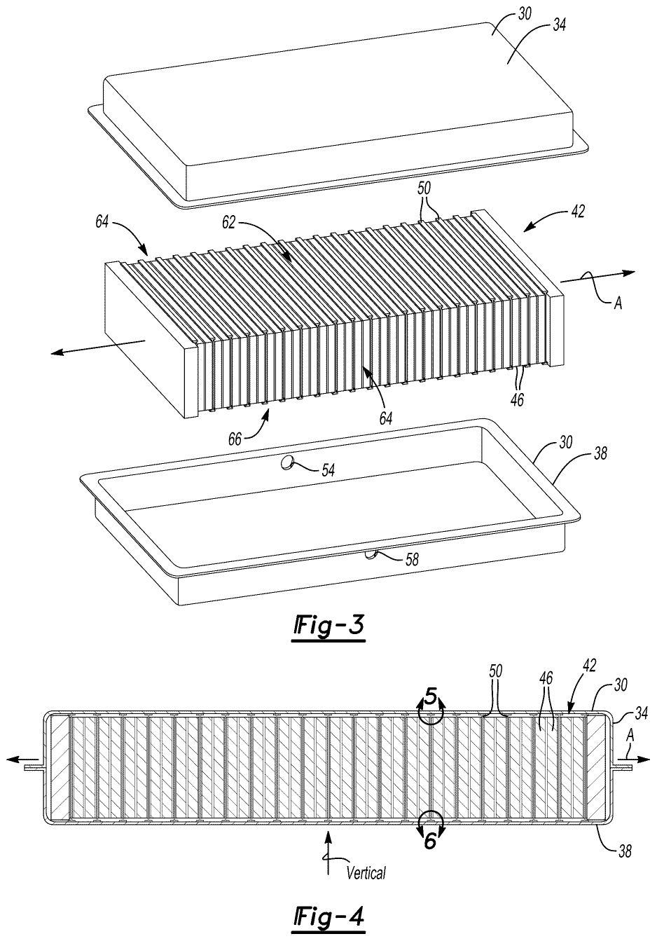

FIGS. 2 and 3 illustrate additional detail of the example battery pack 14. In this example, the battery pack 14 includes an enclosure assembly 30. The enclosure assembly 30 includes enclosure structures—here a cover 34 and a tray 38. The cover 34, in this example, is vertically above the tray 38. In other examples, however, the cover 34 could be arranged below, or to a side of the tray 38.

Various terms such as “vertical,” “above,” “below,” “top,” and “bottom” are used relative to the arrangement of the components of the battery pack 14 in the various drawings and should not otherwise be deemed limiting. These terms are with reference to the general orientation of the battery pack 14 when installed within the vehicle 10 of FIG. 1,

The cover 34 is welded to the tray 38 in one example of this disclosure. While welding is mentioned, the cover 34 and tray 38 could be connected using other fluid-tight connection techniques, such as adhesive. Further, while an exemplary enclosure assembly 30 is shown in the drawings, the enclosure assembly 30 may vary in size, shape, and configuration within the scope of this disclosure.

In this disclosure, a cell stack 42 is arranged within an interior of the enclosure assembly 30. The example cell stack 42 includes a plurality of individual battery cells 46 disposed along a cell stack axis A, and a plurality of support assemblies 50. Each of the support assemblies 50 can be sandwiched between two of the battery cells 46 along the cell stack axis. The battery cells 46 and support assemblies 50 can be compressed along the cell stack axis A between a pair of endplates 52.

The cell stack 42 could include any number of battery cells 46. The battery pack 14 could employ any number of cell stacks 42 within the enclosure assembly 30. Thus, this disclosure is not limited to the exact configuration shown in FIG. 2. Further, while the battery cells 46 and support assemblies 50 of FIG. 3 are positioned side-by-side relative to one another, other configurations are also contemplated within the scope of this disclosure, including but not limited to embodiments in which the battery cells 46 and support assemblies 50 are stacked on top of one another, for example.

In an embodiment, the battery cells 46 are pouch-style, lithium-ion cells. However, battery cells having other geometries (cylindrical, prismatic, etc.), other chemistries (nickel-metal hydride, lead-acid, etc.), or both could alternatively be utilized within the scope of this disclosure.

The cell stack 42 is arranged in the interior of the enclosure assembly 30 between the tray 38 and the cover 34. A thermal management system is used to manage thermal energy levels within the battery pack 14. The example thermal management system is configured to route non-conductive (i.e., dielectric) coolant C over areas of the cell stack 42 to manage thermal energy within the cell stack 42 by, for example, using the coolant C to take on heat from the cell stack 42. The thermal management system is an immersion thermal management system at least because portions of the battery pack 14, here at least the battery cells 46 of the cell stack 42 are immersed in the coolant C.

In this example, the coolant C generally flows from an inlet 54, which is formed near a vertical bottom of the enclosure assembly 30 on the first opposite side of the cell stack 42, to an outlet 58, which is adjacent a vertical top of the enclosure assembly 30 on an opposite, second side of the cell stack 42. The cell stack 42 has a top side 62, opposing outboard sides 64, and a bottom side 66.

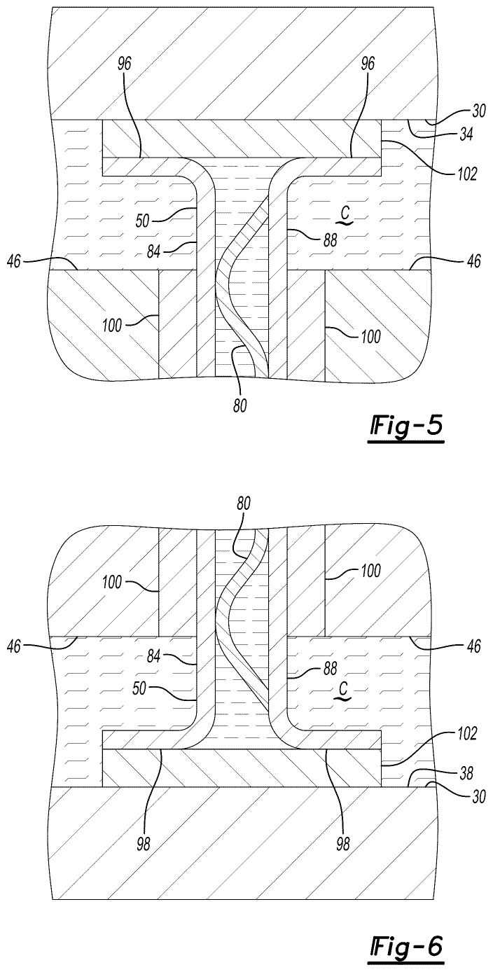

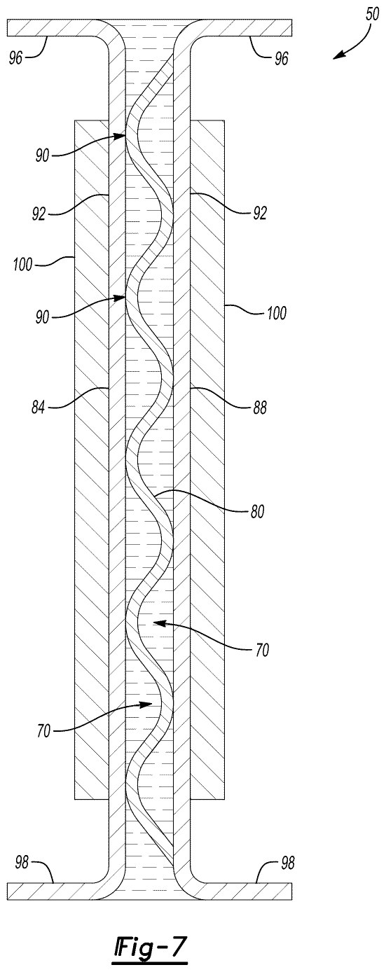

With reference now to FIGS. 4-7 and continuing reference to FIGS. 2 and 3, some of the coolant C communicates through the cell stack 42 in-between the battery cells 46 through at least one channel 70 established by the support assemblies 50. Thermal energy can transfer between the coolant C and the battery cells 46 as the coolant C moves through the at least one channel 70 between the battery cells 46. The channels 70 each open to the outboard sides 64 in this example. In other examples, the channels 70 could extend in another direction, such as vertically and open to both the top side 62 and the bottom side 66 for example.

The example support assemblies 50 each include a spacer 80 sandwiched between a first support fin 84, and a second support fin 88. In this example, the spacer 80 is a corrugated sheet having a plurality of corrugations 90, which give the spacer 80 a wavy profile. The spacer 80 keeps the first support fin 84 spaced from the second support fin 88 to, among other things, provides a space for coolant C to move through the support assemblies 50. The corrugated sheet is configured to flex to permit movement of the first support fin 84 relative to the second support fin 88 along the cell stack axis A.

The first support fin 84 and the spacer 80 establish some of the channels 70. The second support fin 88 and the spacer 80 establish some other channels 70. The channels 70 each have a substantially triangular cross-section in this example. Two sides of the triangle are provided by the spacer 80, and the remaining side is provided by the first support fin 84 or the second support fin 88.

In the exemplary embodiment, the first support fin 84 and the second support fin 88 each have a C-shaped cross-sectional profile. In the support assemblies 50, the fins 84 and 88 are placed adjacent to each other such that the first support fin 84 has a C-shaped profile that opens in a first axial direction, and the second support fin 88 has a C-shaped profile that opens in an opposite, second axial direction.

The fins 84, 88 each have a divider section 92, an upper attachment section 96, and a lower attachment section 98. The upper attachment section 96 extends transversely from the divider section 92 on a first side, here an upper side, of the cell stack 42. The lower attachment section 98 extends transversely from the divider section 92 on a second side of the cell stack 42, which is a lower side of the cell stack 42. The upper attachment sections 96 and the lower attachment sections 98 extend horizontally in this example and overlap horizontally with at least a portion of one of the battery cells 46 of the cell stack 42.

The support fins 84, 88 can span from a floor of the tray 38 to the cover 34. The upper attachment sections 96 are secured to the cover 34 and the lower attachment sections 98 are secured to the tray 38. Thermal energy can pass through the fins 84, 88 to the enclosure assembly 30.

The support fins 84, 88 can be bonded directly to the tray 38 and the cover 34 utilizing adhesive 102, for example. The fins 84, 88 of the support assemblies 50 support the cell stack 42 within the interior of the enclosure assembly 30 such that the cells 46 are elevated and spaced from the floor of the tray 38 and the cover 34.

Within the support assembly 50, the fins 84, 88 have an I-shaped cross-sectional profile. The divider sections 92 combine to give the support assembly 50 a double thickness where the support assembly 50 extends through the cell stack 42, and a single thickness where the support assembly 50 meets the cover 34 and the tray 38. The I-shape can facilitate strengthening the support assembly 50 for tensile loading.

Each of the fins 84, 88 can be a metal or metal alloy. In this example, the fins 84, 88 are aluminum. The fins 84, 88 can be stamped to provide the C-shaped profile.

In this example, the support assemblies 50 each include, in addition to the fins 84, 88, thermal barriers 100 that sandwich the fins 84, 88, and the spacer 80. The thermal barriers 100 block the cells 46 from directly contacting the fins 84, 88 in this example. The thermal barriers 100 can be mica sheets.

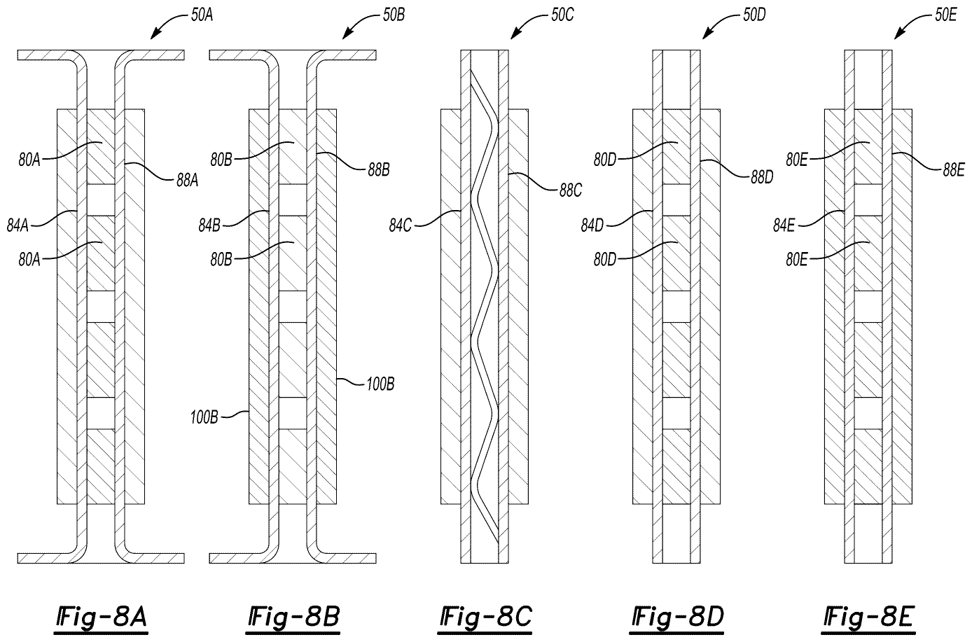

With reference to FIG. 8A, a divider assembly 50A according to another exemplary aspect of the present disclosure incorporates strips of foam as a spacer 80A rather than a corrugated sheet.

With reference to FIG. 8B, a divider assembly 50B according to another exemplary embodiment, uses strips of a thermal barrier material, such as mica, as a spacer 80B rather than a corrugated sheet. Layers of foam 100B prevent the cells 46 from directly contacting the support fins 84, 88.

With reference to FIG. 8C, a divider assembly 50C according to yet another exemplary embodiment using fins 84C, 88C that are planar, not C-shaped. The fins 84C, 88C could be received within respective grooves in an enclosure assembly when installed.

With reference to FIG. 8D, yet another example of divider assembly 50D includes fins 84D, 88D that are planar and sandwiching a spacer 80D provided by strips of foam. The fins 84D, 88D could be received within respective grooves in an enclosure assembly when installed.

With reference to FIG. 8E, in yet another exemplary embodiment, a divider assembly 50E includes fins 84E, 88E that are planar and sandwiching a spacer 80E provided by strips of thermal barrier. The fins 84E, 88E could be received within respective grooves in an enclosure assembly when installed.

Features of disclosed examples include a support assembly that provides space for flow of a coolant between cells, and that guides flow moving between cells. The support assembly can be provided by a thermal barrier that can compress and expand to accommodate expansion and contract of the cells during operation. The support assembly can help to support a cell stack within an enclosure, particularly vibratory and shock loads.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack cell stack assembly, comprising:
a first support fin;
a second support fin; and
a spacer sandwiched between the first support fin and the second support fin to provide a support assembly of a cell stack, the spacer spacing the first support fin from the second support fin to provide a plurality of liquid coolant channels through the spacer assembly.

2. The assembly of claim 1, wherein the first support fin and the second support fin extend from a first enclosure structure on a first side of the cell stack to a second enclosure structure on an opposite, second side of the cell stack.

3. The assembly of claim 2, wherein the first enclosure structure is an enclosure tray and the second enclosure structure is an enclosure cover.

4. The assembly of claim 2, wherein the first support fin and the second support fin each have a C-shaped cross-sectional profile.

5. The assembly of claim 2, wherein the first support fin and the second support fin each have a divider section, and at least one attachment section extending transversely from the divider section.

6. The assembly of claim 5, wherein the first attachment section comprises a first attachment section bonded to an enclosure assembly on a first side of the cell stack, and a second attachment section bonded to the enclosure assembly on an opposite, second side of the cell stack.

7. The assembly of claim 6, wherein the first attachment section is bonded to an enclosure cover of the enclosure assembly, and the second attachment section is bonded to an enclosure tray of the enclosure assembly.

8. The assembly of claim 7, wherein the spacer is a corrugated sheet.

9. The assembly of claim 7, wherein the spacer comprises a plurality of foam strips.

10. The assembly of claim 7, wherein the spacer comprises a plurality of thermal barrier strips.

11. The assembly of claim 1, wherein the spacer is a corrugated sheet, wherein the first support fin and the corrugated sheet establish a plurality of first liquid coolant channels, and the second support fin and the corrugated sheet establish a plurality of second liquid coolant channels, the first and second liquid coolant channels each opening to a first side of the cell stack and to an opposite, second side of the cell stack.

12. The assembly of claim 1, further comprising a first thermal barrier and a second thermal barrier that sandwich the first support fin, the second support fin, and the spacer.

13. The assembly of claim 1, wherein the support assembly is disposed between axially adjacent battery cells within the cell stack.

14. The assembly of claim 1, wherein the support assembly is compressible.

15. The assembly of claim 1, wherein the first support fin and the second support fin are a metal or a metal alloy.

16. The assembly of claim 1, wherein the cell stack is within an interior of an enclosure, the cell stack including a plurality of battery cells disposed along a cell stack axis, the support assembly disposed between the plurality of battery cells along the cell stack axis.

17. The assembly of claim 16, wherein the spacer is a corrugated sheet that is configured to flex to permit movement of the first support fin relative to the second support fin along the cell stack axis.

18. The assembly of claim 1, further comprising a dielectric liquid coolant disposed within liquid coolant channels.

19. A battery pack assembly, comprising:
at least one first battery cell of a cell stack;
at least one second battery cell of the cell stack; and
a support assembly that supports the cell stack within an enclosure assembly, the support assembly is disposed axially between the at least one first battery cell and the at least one second battery cell, the support assembly establishing a plurality of coolant channels configured to guide a liquid coolant through the cell stack between the at least one first battery cell and the at least one second battery cell.

20. The battery pack assembly of claim 19, wherein the support assembly is connected to the enclosure assembly on a first side of the cell stack and on an opposite second side of the cell stack.
